(19) United States
(12) Patent Application Publication
(10) Pub. No.: US 2006/0038409 A1
(43) Pub. Date: Feb. 23, 2006

(54) Fastening apparatus

(76) Inventor: David Falkiner Wallace, Auckland (NZ)

Correspondence Address: JACOBSON HOLMAN PLLC, 400 SEVENTH STREET N.W., SUITE 600, WASHINGTON, DC, 20004, US

(21) Appl. No.: 10/537,308

(22) PCT Filed: Jul. 23, 2003
(86) PCT No.: PCT/NZ03/00161

§ 371 Date: Sep. 2, 2005

(30) Foreign Application Priority Data
Dec. 4, 2002 (NZ) 522958

(51) Int. Cl. E05C 19/10

(52) U.S. Cl. 292/102

(57) ABSTRACT

A fastening apparatus for use with a closure means, including a latch configured to receive a catch that is attached to a closure means, characterised in that the latch includes a lever attached to a release mechanism for the fastening apparatus wherein the lever extends outwards from the closure means when the closure means is held in the open position.

### TECHNICAL FIELD

This invention is directed to improvements in and relating to fastening apparatus.

It is envisaged the fastening apparatus will have particular application in relation to either or both doors and windows, in maintaining/securing the door and/or window in an opened position for a preferred period as required, at which time the fastening apparatus may be released enabling the door and/or window to be closed. However, the invention may have application outside this field.

### BACKGROUND ART

As can be appreciated, there are numerous ways to secure a window, door, gate, tailgate and so forth in an opened position.

Typically the apparatus used involves two separate, but interconnectable parts. One part is typically secured to an adjacent surface such as a wall or post, against which the opened window/door and so forth will lie adjacent to when in an opened position. The second part is typically attached to the door, window, and so forth, itself. Accordingly, when the door/window is in an opened position one part engages with the other part to maintain the door/window in the opened position as required.

Such systems include a hook-and-eye system, a bolt system and so forth. Typically there is an operating portion that may be affixed to either the door/window or the supporting surface as discussed above. Bolt operated systems may operate by moving rectilinearly, pivotally, or rotatably. Operation of the bolt by pulling or applying pressure to a handle portion in a direction towards or away from the direction of the door and/or window determines whether the bolt engages the receiving portion or is released therefrom as required.

Alternately, the fastening device may be in the form of an elongated hook capable of engaging in a keeper or eye to secure the hook in position.

Yet other fastening devices may include springs in conjunction with a pivoting or rectilinearly operated portion to improve the positive engagement or securing of the operating portion with the receiving portion. Spring-loaded latches on gates are an example of this.

Whilst all of the above devices are varying beneficial in securing a door/window/gate and so forth in an opened position, there are disadvantages associated with their use. For example, the hook and eye, or bolt options are required to be manually operated in order to secure the door/window in the first place, and then are typically manually operated to release the operating portion from the engaging portion by either lifting the hook or pulling open the bolt mechanism. Where the system is employed on a door—they are typically positioned towards the top or bottom of the door and therefore to be operated manually require a person to bend or stretch to release the catch and so forth.

The latching systems operating in conjunction with the springs, and so forth have some advantages over the previously described systems in that they may or may not require manual operation to secure the door or window in an open position. Pressure applied to the latch may be sufficient to deform the spring mechanism thereby enabling the latch to engage with the receiving portion on the gate/window/door. However, release of the latch is typically a manual operation requiring depression of a lever to release the latching apparatus. Again the same problems of bending or stretching of the operator is typically required.

Accordingly all of the above may be fiddly and/or difficult to operate depending on the tension or friction inherent when the door is secured in an open position. Where the spring and the latching system is particularly resilient it may require considerable force to enable the latching apparatus to be released.

Further, as such systems are typically positioned in less than convenient places an elderly or infirmed person may find the operation of such systems difficult or painful to achieve. In addition, where significant pressure is required or particular force is required to release the bolt, latch and so forth, the system may be inappropriate for people who lack the requisite strength, or who may be physically impaired (due to arthritis and so forth) to be able to operate such systems.

Further, in some cases where the latching system is used to maintain door/window or gate in an open position in very strong windy situations, the latch mechanism may not be strong enough to retain the receiving portion. Accordingly, the latch mechanism may release the door and/or window that typically slam closed as a result of the wind pressure applied to it. In order to overcome this problem, the spring may be particularly resilient thereby effecting problems discussed above in terms of the release of a latching apparatus to manually close the door or window when required.

In addition, the arrangement of such systems often means that in particularly windy situations there will be horizontal movement between the door/window and the fastening apparatus as the wind buffets the door/window. This continuing buffeting or vibration in windy situations may weaken the fastening apparatus, or may simply cause a repetitive noise that can become irritating to the occupant if it continues over extended periods.

Also, where the fastening apparatus includes a spring/latch type system, or a lever system, typically these are designed to fit either right-opening door/windows or left-opening windows. Whilst some may be designed to be interchangeable, most are not. Therefore it requires the purchase of the correct system for the correct position. If at some future stage the door or window is re-hung, a new latching system may be required.

It would therefore be advantageous to have fastening apparatus that incorporated beneficial features of the above systems whilst at the same time obviating their disadvantages by:
a) having a system that would be able to secure a door/window/gate or similar in an open position by merely applying minimal pressure from the door/window/gate against the fastening apparatus; and
b) having a fastening apparatus that retained the door/window/gate in an open position irrespective of counter pressure or force applied thereto by wind or by physical forces applied to the door/window/gate; and
c) providing a fastening apparatus that securely holds the door/window/gate in an open position without incumbent rattling on windy days; and
d) is able to be released manually without the need to stretch or bend and with minimal discomfort or difficulty for the operator; and
e) is able to fit left or right opening door/window/gate as required using the same fastening apparatus.

It is an object of the present invention to at least address some or all of the foregoing problems identified in prior art systems, or to provide the consuming public with an alternative choice.

Further aspects and advantages of the present invention will become apparent from the ensuing description which is given by way of example only.

### DISCLOSURE OF INVENTION

According to one aspect of the present invention there is provided a fastening apparatus for use with a closure means, including

a latch configured to receive a catch that is attached to a closure means,

characterised in that

the latch includes a lever attached to a release mechanism for the fastening apparatus wherein the lever extends outwards from the closure means when the closure means is held in the open position.

It should be understood that throughout the present specification the term “closure means” should be understood to include any door, window, gate or similar structure that operates as a barrier for closing and opening an entranceway.

It should also be understood that throughout the present specification the terms “latch” and “catch” should be understood to include an apparatus wherein the latch is an assembly that when firmly connected with the complementary catch provides a releaseably secure fit in order to restrain the catch from moving away from the latch until the catch is released by the operator of the apparatus.

In preferred embodiments of the present invention the catch is secured to the closure means as the catch is far smaller than the latch and therefore is far less likely to impede normal operation of the closure means.

It should also be understood that throughout the present specification the term “release mechanism” should be understood to mean any item or assembly that can be manipulated to effect the separation of the catch from the latch.

In preferred embodiments of the present invention the fastening apparatus includes a back-plate for affixing the latch to a surface.

It should be appreciated that the surface may be any suitable surface in the proximity of the position where it is desired to secure the closure means when in an open position.

Also in preferred embodiments of the present invention the lever is centrally pivoted with respect to the back-plate.

This should not however be seen to be a limitation on the present invention in any way as in other embodiments the lever can be pivoted at any point along its length with respect to the back-plate, or the fastening apparatus can be secured directly to a surface without the use of a back-plate.

In preferred embodiments of the present invention the latch includes a notched section that is configured to be substantially perpendicular to the axis of the lever.

It should be understood that with in all preferred embodiments of the present invention when the latch and the catch are brought together to effect the securement of the closure means, the catch contacts the notched section of the latch and causes the latch to be displaced in a substantially vertical plane as the catch continues to move against the latch until the catch is aligned with a notch contained in the notched section of the latch, wherein the displacing force on the latch provided by the catch will cease and the latch will attempt to return to its former position with the result that the catch will be held in its new position within the notch until the lever is depressed to release the catch and hence the closure means.

It should be appreciated that the length of the notched section of the latch determines the distance between the closure means and the surface to which the fastening apparatus is secured, when the closure means is secured in the open position.

In preferred embodiments of the present invention the length of the notched section is sufficient in order to ensure that no damage occurs to the closure means or any other surface when the closure means is secured in an open position or during the operation of the fastening apparatus.

It should be appreciated that in some preferred embodiments of the present invention the notched section has a plurality of notches—which can be located on both the upper and lower surfaces of the notched section.

It should also be understood that the catch of the present invention is configured in order that it can be secured by the notched section of the latch.

In preferred embodiments of the present invention the latch is configured in a manner that allows the catch to be released (and hence the closure means) from the latch by downward pressure being applied to the opposite end of the lever to that containing the notched section.

In some preferred embodiments of the present invention the latch assembly includes a cushioning device that extends in a substantially perpendicular plane to the main axis of the lever and is substantially in the same plane as the notched section.

It should be appreciated that within preferred embodiments that contain the cushioning device then the cushioning device length is such that the closure means contacts the cushioning device when the closure means is held in an open position by the present invention.

It should also be appreciated that within some preferred embodiments of the present invention the area of the cushioning device against which the closure device contacts is substantially flat.

This should not be seen to be a limitation on the present invention in any way as in some other embodiments the contact areas may be ribbed or contain an area of texturing of one form or another.

In preferred embodiments of the present invention the notched section is held in a position where it will apply a positive force onto the catch, when the closure means is held in the open position, by the effects of a biasing device associated with the latch.

It should be appreciated that although in most preferred embodiments of the present invention the biasing device is a spring, this should not be seen to be a limitation on the present invention in any way as in other embodiments the biasing device can be any other suitable device.

In most embodiments of the present invention the biasing device is attached between the lever and the back-plate, at the point where the lever is secured to the back-plate, wherein one end of the biasing device is attached to the lever with the other end of the biasing device being anchored to the back-plate.

The biasing device is positioned in order to be able to pivot the latch through a substantially vertical plane and to apply a positive downward force onto the end of the latch that contains the notched section and hence to ensure that the catch is secured to the latch by the notched section when the closure means is held in its open position.

This has the advantage in that it ensures the secure engagement of the latch and the catch—even in situations where strong winds or gusts of air are likely to buffet the closure device—whereas without the inclusion of the biasing device and its operation on the latch then in these situations the latch and the catch may be accidentally disengaged.

In embodiments where the cushioning device is fitted to the latch then the apparatus would have the additional advantage in that the cushioning device will operate as a positive stop (damping means) in relation to the closure means in order to prevent the closure means from rattling or vibrating due to the wind.

It should be appreciated that in some preferred embodiments of the present invention the extent of the downward positioning of the notched section is controlled by a restraint device that inhibits the movement of the lever past a pre-defined point.

In most preferred embodiments of the present invention the restraint device is constructed as a section of the back-plate that is substantially perpendicular to the normal axis of the lever.

Once again this should not be seen to be a limitation on the present invention in any way as in other embodiments the restraint device can be any suitable device that is capable of limiting the extent to which the notched section moves downwards when it is not engaged with the catch.

It should be appreciated that the present invention is intended to be reversible and can therefore be used with either or both a left-handed or right-handed closure means.

In preferred embodiments of the present invention the altering of the invention from left-handed to right-handed use (and vice versa) can be effected by simply disassembling the latch assembly and the biasing device from the back-plate, reversing their position with respect to the back-plate and then reassembling them to the back-plate.

It should be appreciated that in some embodiments a new biasing device will have to be fitted, however in some other embodiments it is envisaged that the same biasing device can be re-used by being reversed and then refitted.

In preferred embodiments of the present invention the catch is configured to be substantially U-shaped.

This also should not be seen to be a limitation on the present invention in any way as in other embodiments the catch can be constructed in any configuration that is suitable to be secured by the latch.

It should be appreciated that an elongated portion of the catch includes, or is adapted to receive, an attachment assembly to secure the catch against the closure means.

In preferred embodiments of the present invention a section of the lever is configured to be substantially flattened in order to provide a greater contact area between an appropriate item (such as a persons foot or hand) during the application of an appropriate pressure in order to release the latch from the catch when the closure means is required to be released.

It should also be appreciated that this flattened section of the lever may also include ribbing or ridges or any other form of texturing of the surface, or may in some embodiments include an additional item such as a rubber pad or coating in order to improve the grip of the flattened area of the latch.

It should be appreciated that in most embodiments the present invention is intended to be attached to an area toward the bottom of the closure means in order that it can be more easily foot-operated by simply applying pressure via the operators foot to the flattened area of the latch that extends past the perimeter of the closure means in order to release the latch from the catch, thereby enabling the release of the closure means.

The most significant advantage of the present invention is that this releasing operation of the catch from the latch is possible without having to place an object, such as a hand or a foot, between the closure means and the surface to which the back-plate is affixed by the fact that the lever extends outward past the perimeter of the closure means when the closure means is secured in the open position by the fastening apparatus.

It should be noted that this feature is a particular advantage for the elderly, disabled, infirm, etc.

This also has the additional advantage in that the release of the catch from the latch can be enacted quite quickly and only needs a low level of precision by the operator for the operation to be successful.

It should be appreciated that in most preferred embodiments of the present invention will be constructed from durable materials, materials used for external applications will also be weatherproof.

It should also be appreciated that the cushioning device will be constructed of any material that exhibits elastic deformation to the extent that the cushioning apparatus is capable of cushioning the closure means as required to minimise noise and/or vibration during windy conditions etc.

It should be appreciated that the present invention can be applied not only to doors, windows, gates etc but may also be used in other less obvious applications such as the tailgate on trailers, or indeed any area where the object is required to be held in a position from where it can be easily released when necessary.

### BRIEF DESCRIPTION OF DRAWINGS

Further aspects of the present invention will become apparent from the following description which is given by way of example only and with reference to the accompanying drawings in which:

FIG. 1 a diagrammatic perspective view of the fastening apparatus in accordance with one preferred embodiment of the present invention; and

FIG. 2 a diagrammatic perspective view of the fastening apparatus in accordance with another preferred embodiment of the present invention.

### BEST MODES FOR CARRYING OUT THE INVENTION

With reference to the diagrams by way of example only there is provided a fastening apparatus (generally indicated by arrow 1).

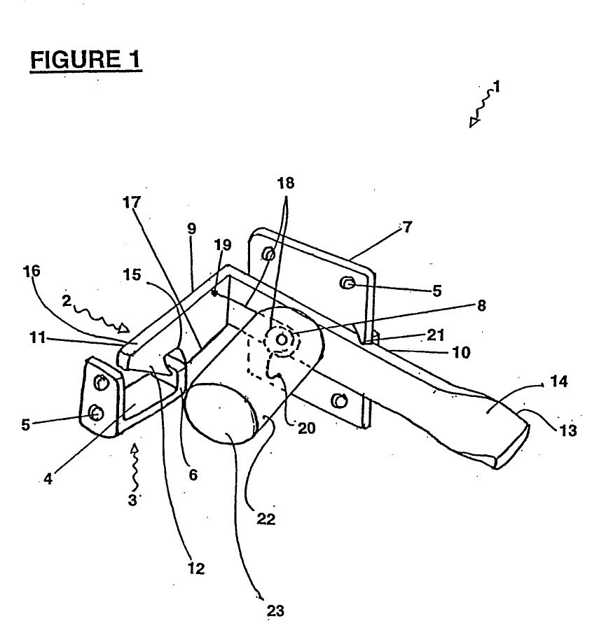

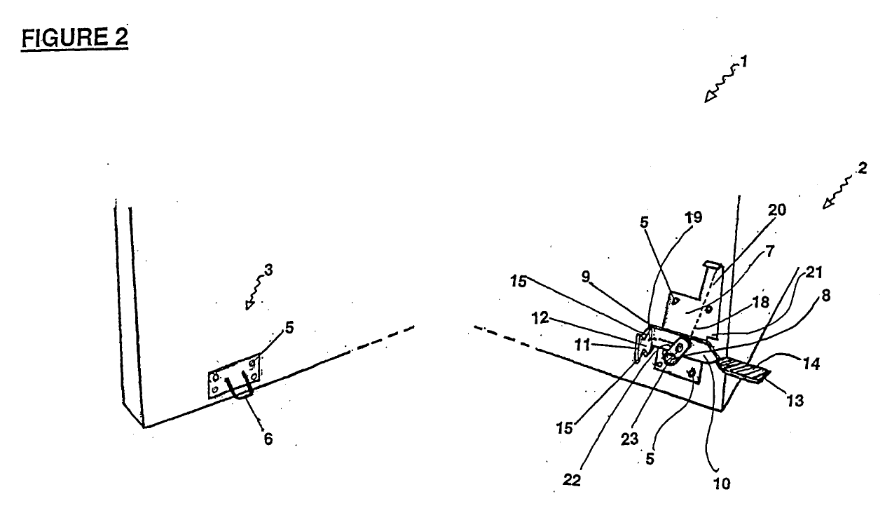

As shown in FIGS. 1 and 2 the fastening apparatus (1) includes a latch (generally indicated by arrow 2) and a catch (generally indicated by arrow 3).

The catch (3) is typically applied to the door/window/gate or any other such closure means, required to be maintained and/or secured in an opened position for a preferred period of time.

The catch (3) of FIGS. 1 and 2 is configured to be substantially U-shaped. An elongated portion (4) of the U-shaped catch (3) includes or is adapted to receive an attachment apparatus (5) to secure the catch (3) against the closure means.

The opposite side (6) of the U-shaped portion is configured to effect engagement with the appropriately configured portion (15) on the latch (2).

The latch (2) includes a back-plate (7) to affix the latch (2) to a surface against which the closure means is required to be secured when in an opened position.

Accordingly as similar to the attachment apparatus (5) of the catch (3), the back-plate (7) is configured to be able to be secured to a surface.

The lever (10) is located on the back-plate (7). The lever (10) includes a notched section (9) extending at a right-angle from the lever (10).

Towards the leading distal end (11) of the notched section (9) there is an engaging portion (12), whilst towards the trailing distal end (13) of the lever portion (10) there is provided a handle (14).

The handle (14) is configured to be substantially flattened in order to increase the area over which the appropriate pressure is applied in order to release the latch (2) from the catch (3) when the closure means is required to be closed.

As can be seen in FIG. 2 the notched section (9) may include notches (15) on both the upper (16) and lower (17) surfaces of the engaging portion (12) of the latch (2). This configuration enables the latch (2) to be substantially reversed when required for use on either, or both, left or right opening closure means.

The notches (15) may be configured as required to effect engagement with the complementarily configured catch (3).

To effect the operation of the latch (2) there is provided a biasing means in the form of a spring (18) that is located substantially centrally (at 8) relative to the back-plate (7). One end of the spring (18) is attached (at 19) to the notched section (9) of the lever (10) and is resiliently wound at the point at which the lever (10) is attached to the centre (8) of the back-plate (7). The opposite end of the spring (18) is attached (at 20) to the back-plate.

The spring (18) is positioned to effect the pivotal movement of the latch (2) through a substantially vertical plane.

However, the spring (18) is arranged such that the notched section (9) of the latch (2) is substantially biased downwards when the latch (2) is not engaged with the catch (3).

Accordingly, this continuous bias in a substantially downward direction effects positive pressure on the catch (3) when the latch (2) is engaged with the catch.

The downwards positive pressure further operates to effect secure engagement and cooperation between the latch (2) and the catch (3) even when strong winds may buffet the closure means and may otherwise cause the release of the latch (2) from the catch (3).

To further prevent the latch (2) being released from the catch (3) there is provided a restraint device (21). The restraint device (21) as shown in FIG. 1 includes a substantially angled portion (21) of the back-plate (7) that maintains the trailing distal end (13) of the lever (10) in a preferred orientation.

To further improve the operation of the fastening apparatus (1) there is also provided a cushioning apparatus (22) that is positioned substantially over the point of attachment (at 8) of the spring (18) and the lever (10) to the back-plate (7). The cushioning apparatus (22) is made of a substantially rubber or thermoplastics material that is capable of being elastically deformed to some extent when in contact with the closure means.

The cushioning apparatus (22) extends from the back-plate (7) in a substantially perpendicular plane. The cushioning apparatus (22) is substantially elongated and extends beyond the length of the notched section (9) such that when the latch (2) is engaged with the catch (3) the cushioning apparatus (22) is substantially in line with the point of attachment of the catch (3) to the closure means.

Accordingly, in particularly windy situations the cushioning apparatus (22) operates as a positive stop or dampening device to prevent or limit the closure means vibrating in the wind and causing noise as a result of the catch (3) rattling within the notch (15) of the notched section (9).

The cushioning apparatus (22) further acts to prevent damage to the closure means or any structure extending from the closure means, (such as a handle or door knob) due to movement of the closure means against the adjacent surface, in the wind.

Whilst the contact edge (23) as shown in FIG. 1 is substantially flat, it can be appreciated that this face (23) may be ribbed or otherwise configured.

As also can be appreciated, the handle (14) of the lever (10) may also include ribbing or ridges, or may include a substantially rubber portion to improve grip on the handle (14).

As the fastening apparatus (1) is preferably attached to operate at the bottom of a closure means, it can be appreciated that the latch (2) may be foot-operated by simply applying foot pressure to the handle catch (14) as required, to release the latch (2) from the catch (3) to enable the closure means to be closed when required.

Aspects of the present invention have been described by way of example only and it should be appreciated that modifications and additions may be made thereto without departing from the scope thereof as defined in the appended claims.

1. A fastening apparatus for use with a closure means, including a latch configured to receive a catch that is attached to a closure means, characterised in that the latch includes a lever attached to a release mechanism for the fastening apparatus wherein the lever extends outwards from the closure means when the closure means is held in the open position and there is a cushioning apparatus intermediate of the latch and the closure means, said cushioning apparatus cushioning by contact with said closure means with respect to said latch.

2. A fastening apparatus as claimed in claim 1 wherein the latch includes a back-plate for fixing the latch to a preferred surface.

3. A fastening apparatus as claimed in claim 1 wherein the lever is centrally pivoted with respect to the back-plate.

4. A fastening apparatus as claimed in claim 1 wherein the release mechanism includes a notched section of the lever.

5. A fastening apparatus as claimed in claim 4 wherein the notched section is angled in a substantially perpendicular plane with respect to the back-plate in order to effect the required distance between the surface to which the back-plate is affixed and the closure means-when the catch and the latch are engaged.

6. A fastening apparatus as claimed in claim 4 wherein the notched section includes at least one notch for engaging with a complementary catch.

7. A fastening apparatus as claimed in claim 1 wherein the latch is released from the catch by the application of pressure to the opposite distal end of the lever with respect to the notched section.

8. A fastening apparatus as claimed in claim 1 wherein the latch includes a cushioning apparatus.

9. A fastening apparatus as claimed in claim 8
wherein the cushioning apparatus is positioned to extend in a substantially perpendicular plane with respect to the back-plate and to contact the closure means when the closure means is secured by the fastening apparatus.

10. A fastening apparatus as claimed in claim 4 wherein the catch is configured to be able to engage with the notched section on the complimentary latch.

11. A fastening apparatus as claimed in claim 1 wherein the latch is configured such that it can be used with either a left handed or right handed opening closure means.

12. A fastening apparatus as claimed in claim 1 wherein the catch is configured to be substantially U-shaped.

13. A fastening apparatus as claimed in claim 12 wherein the catch is configured to receive an attachment to secure the catch against the closure means.

14. A fastening apparatus as claimed in claim 12 wherein the catch includes an attachment apparatus to secure the catch against a closure means.

15. A fastening apparatus as claimed in claim 4 wherein the notched section of the lever is located towards the leading distal end of the lever and a handle is located towards the trailing distal end of the lever.

16. A fastening assembly as claimed in claim 16 wherein the notched section is configured to be substantially right-angled to the axis of the lever.

17. A fastening apparatus as claimed in claim 17 wherein the notched section includes notches on both the upper and lower surfaces of the notched section.

18. A fastening assembly as claimed in claim 1 wherein a biasing means is located substantially centrally to the lever.

19. A fastening apparatus as claimed in claim 18 wherein the biasing means is a spring.

20. A fastening apparatus as claimed in claim 18 wherein the biasing means is attached to the lever at the point at which the lever is attached to the back-plate.

21. A fastening apparatus as claimed in claim 20 wherein one end of the biasing means is attached to the lever whilst the other end of the biasing means is attached to the back-plate.

22. A fastening assembly as claimed in claim 18 wherein the biasing means is positioned to effect a pivotal movement on the lever through a substantially vertical plane.

23. A fastening apparatus as claimed in claim 22 wherein the biasing means ensures that the leading distal edge of the latch is biased downwards from the horizontal when the latch is not engaged with the catch.

24. A fastening apparatus as claimed in claim 18 wherein the biasing means exerts a positive pressure in a substantially downward direction onto the catch when the catch is engaged with the latch.

25. A fastening apparatus as claimed in claim 1 wherein the latch includes a restraint device that is configured as a substantially angled portion of the back-plate that limits the upward movement of the trailing distal end of the lever past a pre-defined point.

26. A fastening apparatus as claimed in claim 8 wherein the cushioning apparatus is positioned substantially over the point of attachment of the biasing means and the lever to the back-plate.

27. A fastening apparatus as claimed in claim 27
wherein the cushioning apparatus is constructed of a material that exhibits elastic deformation under the application of direct pressure.

28. A fastening apparatus as claimed in claim 26 wherein the cushioning apparatus operates as a positive stop against the closure means.

29. A fastening apparatus as claimed in claim 26 wherein the cushioning apparatus operates as a movement damping device against the closure means.

30. A fastening apparatus as claimed in claim 15 wherein the handle of the lever is configured to have a partially textured surface.

31. A fastening apparatus as claimed in claim 15 wherein the handle of the lever includes a substantially rubber-like area.

32. (canceled)

33. (canceled)
